(19) United States
(12) Patent Application Publication
(10) Pub. No.: US 2026/0351467 A1
(43) Pub. Date: Nov. 5, 2026

(54) DRY-TYPE TRANSFORMER WITH GROUNDING AND BONDING PROVISION

(71) Applicant: Hammond Power Solutions Inc., Guelph (CA)

(72) Inventors: Moonhee Lee, Guelph (CA); Tadeh Armenian, Guelph (CA)

(21) Appl. No.: 19/665,880

(22) Filed: May 1, 2026

Related U.S. Application Data
(60) Provisional application No. 63/798,476, filed on May 1, 2025.

(51) Int. Cl. H01F 27/28; H01F 27/02; H01F 27/29; H01F 30/06; H01R 4/34

(52) U.S. Cl. CPC H01F 27/2852; H01F 27/02; H01F 27/29; H01F 30/06; H01R 4/34

(57) ABSTRACT

A grounding and bonding provision system can include a dry-type transformer with a transformer termination. A grounding tab can extrude from one or more non-current carrying and conductive parts of the dry-type transformer. A conductor link can include a plurality of bends arranged to position the conductor link between the grounding tab and the transformer termination. One or more screws can removably secure the conductor link to the grounding tab and the transformer termination.

### CROSS-REFERENCE TO RELATED APPLICATIONS

This application claims priority to and the benefit of U.S. Provisional Application No. 63/798,476, filed on May 1, 2025, which is incorporated herein by reference in its entirety.

### BACKGROUND

Dry-type transformers are electromagnetic devices for stepping up or down supply voltages. Dry type transformers can be found in a control panel used to provide voltage needs for various industrial and/or commercial facilities. To meet electrical codes and standards, all non-current carrying metal parts, as well as secondary windings of the dry-type transformer, are typically grounded and bonded. Non-current carrying metal parts and secondary windings may be bonded and/or grounded to several locations within the control panel. Dry-type transformers lack a shared grounding or bonding point for non-current-carrying metal parts and secondary winding terminations. The responsibility of grounding and bonding all required components within the installation falls on the installers of these transformers. This invention simplifies this process. Without it, the grounding and bonding might not be consistently achieved by the installer.

### BRIEF SUMMARY

According to some aspects, the present disclosure provides a grounding and bonding provision system. The grounding and bonding provision system can include a dry-type transformer with a transformer termination. A grounding tab can extrude from one or more non-current carrying and conductive parts of the dry-type transformer. A conductor link can include a plurality of bends arranged to position the conductor link between the grounding tab and the transformer termination. One or more screws can removably secure the conductor link to the grounding tab and the transformer termination.

According to some aspects, the present disclosure provides a grounding and bonding provision system. The grounding and bonding provision system can include a conductor link. The conductor link can include a plurality of bends arranged to position the conductor link between a grounding tab and a transformer termination of a dry-type transformer. The plurality of bends can include a first 90 degree bend between a first section and a second section. The first section can include a first end of the conductor link. A second 90 degree bend can be between the second section and a third section. The second 90 degree bend can be in an opposite direction of the first 90 degree bend. A third 90 degree bend can be between the third section and a fourth section. The third 90 degree bend can form a U-shape with the second 90 degree bend. A fourth 90 degree bend can be between the fourth section and a fifth section. The fifth section can include a second end of the conductor link. One or more screws can secure the conductor link to the grounding tab and the transformer via a first slot on the first section and/or a second slot on the fifth section.

According to some aspects, the present disclosure provides an electrical control panel. The electrical control panel can include a dry-type transformer. The dry-type transformer can include a transformer termination. A grounding tab can be coupled to one or more non-current carrying and conductive parts of the electrical control panel. A conductor link can include a plurality of bends arranged to position the conductor link between the grounding tab and the transformer termination. One or more screws can removably secure the conductor link to the grounding tab and the transformer termination.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 shows an example industrial control transformer with a secondary winding being grounded using a wire, according to aspects of the present disclosure.

FIG. 2 the example industrial control transformer of FIG. 1 attached to a steel mounting plate, according to aspects of the present disclosure.

FIG. 3A shows a schematic diagram of a single-phase transformer not bonded or grounded.

FIG. 3B shows a schematic diagram of the single-phase transformer properly bonded and grounded, according to aspects of the present disclosure.

FIG. 4A shows schematic diagram of a three-phase transformer not bonded or grounded.

FIG. 4B shows a schematic diagram of the three-phase transformer properly bonded and grounded, according to aspects of the present disclosure.

FIG. 5 shows an example dry-type transformer with a grounding and bonding provision system, according to aspects of the present disclosure.

FIG. 6 shows an enlarged view of the grounding and bonding provision system of FIG. 5, according to aspects of the present disclosure.

FIG. 7 shows an example of a conductor link, according to aspects of the present disclosure.

FIG. 8 shows another example of a conductor link, according to aspects of the present disclosure.

FIG. 9 shows an example dry-type transformer with a grounding and bonding provision system, according to aspects of the present disclosure.

FIGS. 10A and 10B show an example of the conductor link, according to aspects of the present disclosure.

FIG. 11 shows an example of a grounding and bonding provision system with a common grounding and bonding bus bar, according to aspects of the present disclosure.

FIG. 12 shows an enlarged view of the grounding and bonding provision system of FIG. 11, according to aspects of the present disclosure.

FIG. 13 shows an example of a grounding and bonding provision system with a grounding conductor and mechanical lug, according to aspects of the present disclosure.

FIG. 14 shows an enlarged view of the grounding and bonding provision system of FIG. 13, according to aspects of the present disclosure.

FIG. 15 shows an example of a captive washer ground screw according to aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

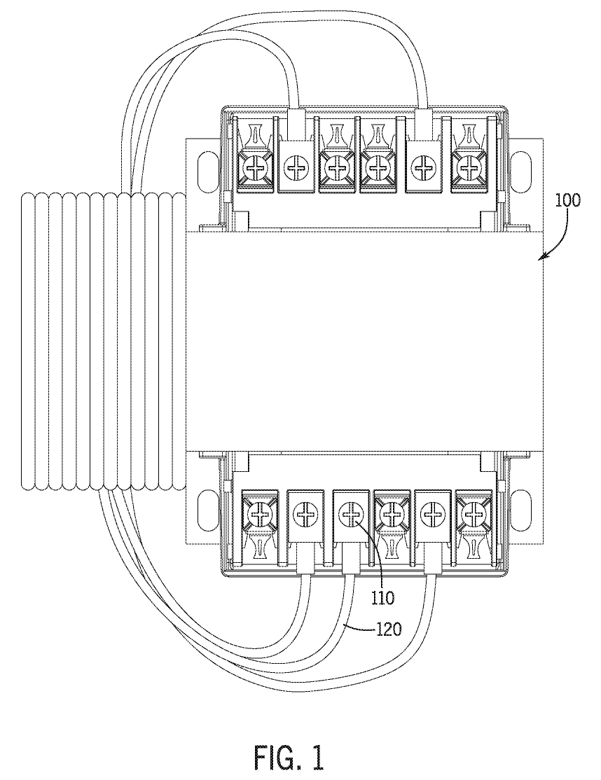

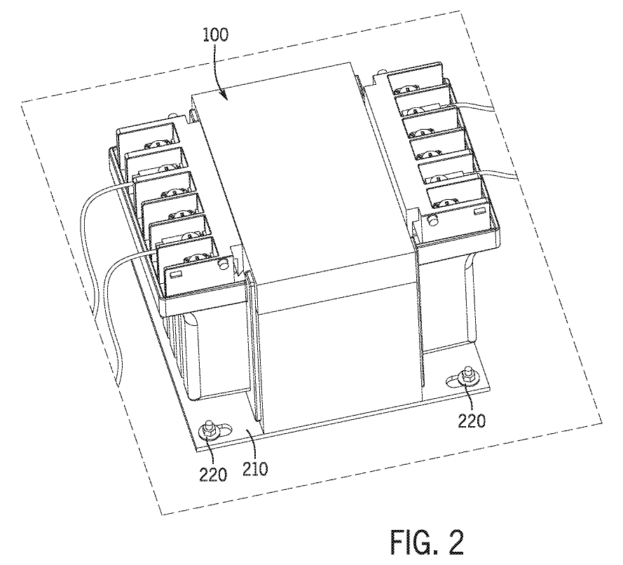

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

The invention will now be described more specifically with reference to the following embodiments. It is to be noted that the following embodiments are presented herein for purpose of illustration and description only. It is not intended to be exhaustive or to be limited to the precise form disclosed.

As should be noted, there are dry-type transformer installation requirements imposed by various governing agencies, laws, rules, and regulations. For example, rules set forth in the National Electrical Code (NEC) impose a responsibility of an installer of a dry-type transformer to bond the transformer to ground. In all instances, the installer is required to ground the secondary windings of the dry-type transformer within an electrical circuit (i.e., an industrial electrical control panel). For example, FIG. 1 illustrates an industrial control transformer 100 with a secondary winding 110 being grounded using a wire 120, which can be missed during installation of transformers, leading to non-compliance with installation requirements. Further, the installer is required to bond all non-current carrying metal parts of the dry-type transformer within an industrial electrical control panel. For example, FIG. 2 illustrates non-current carrying metal parts of the industrial control transformer 100 electrically connected and bonded to a mounting plate 210 via fasteners 220. In some examples, the dry-type transformer may be an industrial control transformer that includes non-current carrying metals parts, such as a top steel plate, a steel baseplate, core steel, and metal core clamping fasteners to be bonded.

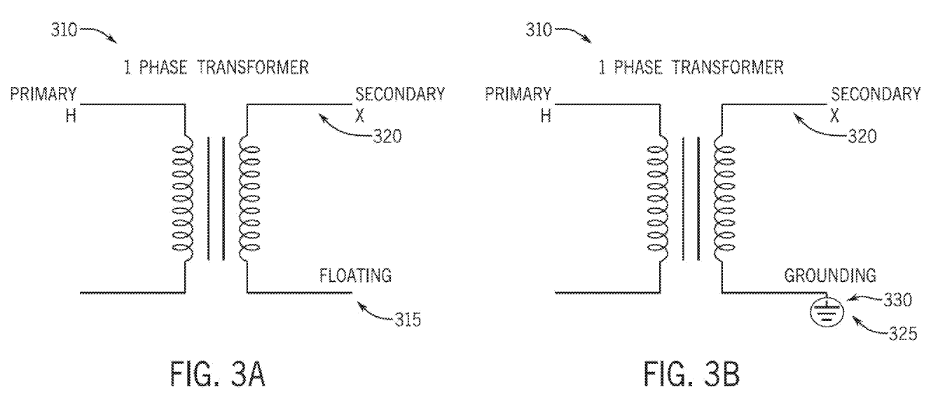

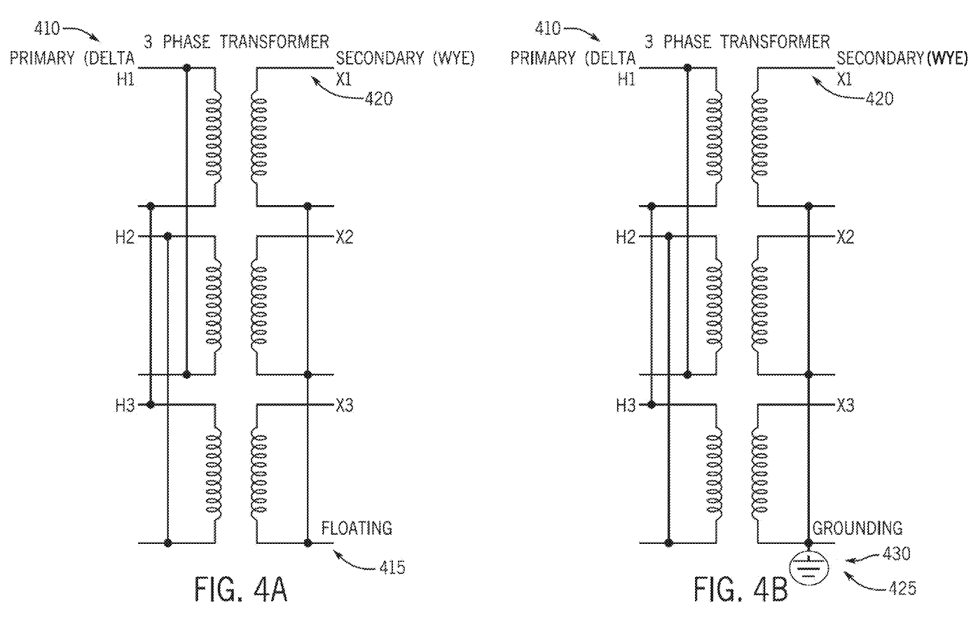

Examples of the disclosed technology may provide a grounding and bonding provision system that can address the various items noted above, as well as others. For example, the disclosed technology may address commonly overlooked steps regarding the installation of transformers by combining common grounding and bonding points for non-current carrying metal parts. Some configurations of the disclosed grounding and bonding provision system can be used to provide a pre-engineered method for grounding and bonding secondary windings (or taps connected thereto) and non-current carrying metal parts of a dry-type transformer. FIG. 3A illustrates a schematic diagram of a single-phase transformer 310 in a floating configuration 315 where the single-phase transformer 310 is not bonded or grounded. In the floating configuration 315, a secondary winding 320 of the single-phase transformer 310 is not connected to ground. FIG. 3B illustrates a schematic diagram of the single-phase transformer 310 in a grounded configuration 325 using the grounding and bonding provision system described herein. In the grounded configuration 325, the secondary winding 320 is properly secured to ground 330, providing a defined voltage reference and a low-impedance fault current path. In addition, the non-current carrying metal parts of the single-phase transformer 310 are bonded to other non-current carrying metal parts. Similarly, FIG. 4A illustrates a schematic diagram of a three-phase transformer 410 in a floating configuration 415, where the three-phase transformer 410 is not bonded or grounded. In the floating configuration 415, a secondary (or wye) winding 420 is not secured to ground. FIG. 4B illustrates a schematic diagram of the three-phase transformer 410 in a grounded configuration 425 using the grounding and bonding provision system described herein. In the grounding configuration 425, the secondary (or wye) winding 420 is properly secured to ground 430. In addition, the non-current carrying metal parts of the three-phase transformer 410 are bonded to other non-current carrying metal parts.

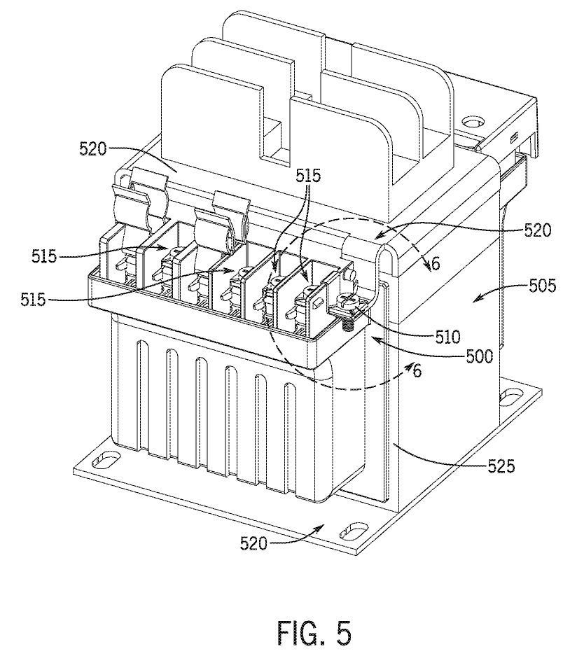

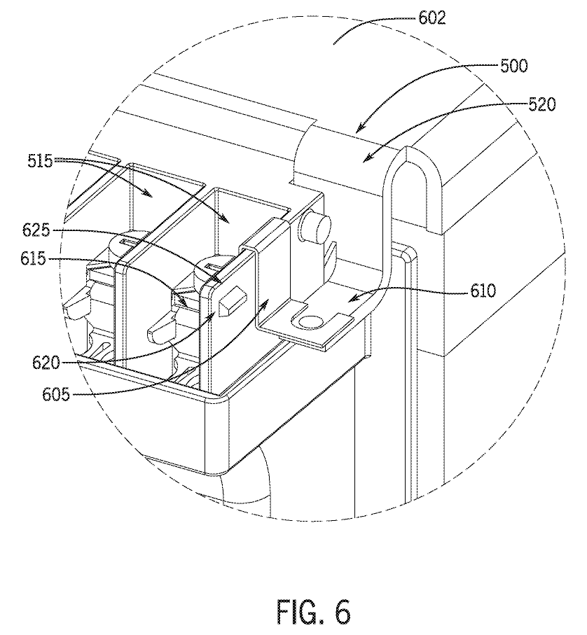

FIG. 5 illustrates a first example grounding and bonding provision system 500, including a dry-type transformer 505. The dry-type transformer 505 can include a single-phase transformer, a poly-phase transformer, or a transformer with multiple-windings and/or phases. In some examples, the dry-type transformer 505 may be an industrial control transformer, a distribution transformer, an encapsulated (potted) transformer, a power transformer, a buck-boost transformer, a motor control transformer, or the like. In particular, the grounding and bonding provision system 500 can eliminate unnecessary wiring and simplify the installation of a dry-type transformer by providing a common location for both grounding and bonding. As illustrated in FIG. 6, some configurations of the disclosed grounding and bonding provision system 500 can include a conductor link 605, a grounding tab 610, a transformer termination 615, and a captive washer ground screw 510.

As shown in FIGS. 5 and 6, in some embodiments, the grounding tab 610 can be located on the body 602 of a dry-type transformer 505. The grounding tab 610 may extend from a top surface 520 of the dry-type transformer 505 towards a plane defined by one or more phase terminals 515. In particular, the grounding tab 610 may be oriented parallel to the top surface of the dry-type transformer 505 and extend perpendicularly to a side surface 525 of the dry-type transformer 505. In some examples, the grounding tab 610 may be a metal tab coupled to a steel part of the dry-type transformer, which may be constructed during the manufacturing of the dry-type transformer. In some examples, the grounding tab 610 may be a metal tab extruding from steel parts of the dry-type transformer, which may be constructed during the manufacturing of the dry-type transformer. In further examples, the metal tab may be constructed using ferrous and non-ferrous electrical current carrying metals, such as steel and other steel alloys, brass, copper, aluminum, stainless steel, etc.

During normal operation of the dry-type transformer 505, there is no current flowing through the conductor link 605 and the grounding tab 610. For example, under normal operation, a closed loop is formed between the dry-type transformer 505 and any connected load. The closed loop can allow the current to travel from the dry-type transformer 505 to the load and back. Moreover, there may be no path between the secondary side of the dry-type transformer 505 and ground, creating an open circuit. For example, during normal operation, electricity, or electrical current, may follow a path of least resistance through a neutral conductor in the dry-type transformer 505, rather than through the conductor link 605 and the grounding tab 610.

When an electrical fault occurs (e.g., a fault due to a short circuit, a breakdown in insulation, an interruption, etc.), the current can flow from the dry-type transformer 505, through the fault, to the ground, creating a fault path. During electrical faults, the conductor link 605 can provide an additional path for current to flow to ground, through the dry-type transformer 505. In some examples, the resistance along the fault path may be less than the resistance on the neutral conductor, causing the fault current to flow along the fault path. The conductor link 605 can provide a low resistance path through the dry-type transformer 505. In some examples, the current flowing through these paths can increase during an electrical fault, allowing the fault current to be detected by circuit protection devices, such as circuit breakers, fuses, etc.

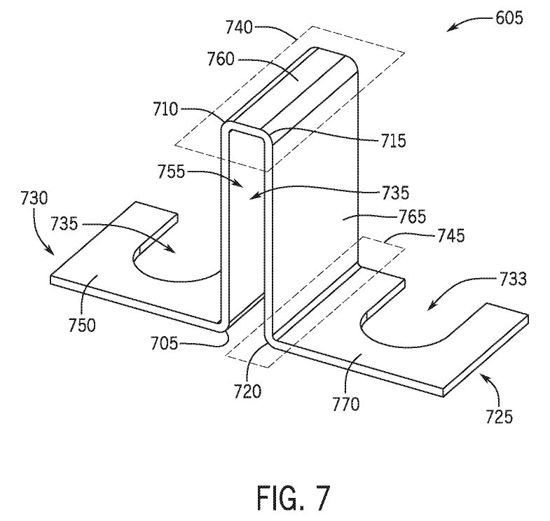

FIG. 7 shows a first example of the conductor link 605. The conductor link 605 may be constructed from one or more pieces of a conductive metal, bent or formed to a shape that fits snugly into or onto a terminal wall 620 of a dry-type transformer. The conductive metal may be a ferrous or a non-ferrous electrical current carrying metal, such as a steel alloy, brass, copper, aluminum, stainless steel, etc. As shown in FIG. 7, in one embodiment, the conductor link 605 can include four bends 705, 710, 715, 720. Two of the bends 710 and 715 may be adjacent to one another, forming a U-shaped portion 740 that can allow the conductor link 605 to rest on a ledge or lip 625 of a terminal wall 620. The other two bends 705 and 720 may create two L-shaped portions 745 between bends 710, 715 and ends 725, 730 of the conductor link 605. In particular, bend 705 may form a 90 degree angle between a first section 750 and a second section 755 of the conductor link 605, while bend 710 may form a 90 degree angle between the second section 755 and a third section 760 of the conductor link 605. Moreover, bend 715 may form a 90 degree angle between the third section 760 and a fourth section 765 of the conductor link 605, while bend 720 may form a 90 degree angle between the fourth section 765 and a fifth section 770 of the conductor link 605.

The conductor link 605 can include a first end 725 and a second end 730. The first end 725 may be configured to contact a surface of grounding tab 610. The second end 730 may be configured to contact a surface of the transformer termination 615. As illustrated in FIG. 7, the first end 725 and the second end 730 can each include a slot or region of empty space 733 and 735, respectively, configured to receive a fastening element to secure the first end 725 and the second end 730 to the grounding tab 610 and the transformer termination 615, respectively. In some examples, the conductor link 605 may be sized to have a cross-sectional area approximately equal to a cross section of a low-voltage neutral conductor or electrically equivalent conductor within an electrical system in which the conductor link 605 is installed.

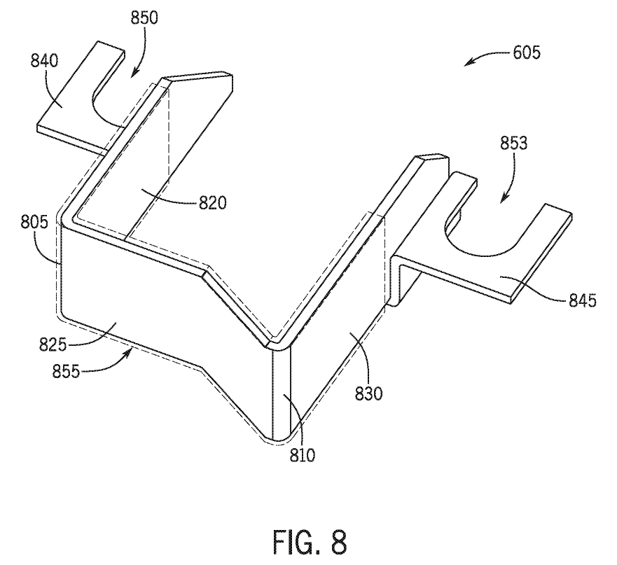

FIG. 8 shows a second example of the conductor link 605. As shown in FIG. 8, the conductor link 605 can include two bends 805, 810. One of the bends 805 may form a 90 degree angle between a first section 820 and a second section 825, while bend 810 may form a 90 degree angle between the second section 825 and a third section 830. The second section 825 may extend over one or more phase terminals 515 and/or other channels on a transformer. For example, the second section 825 may extend over a channel containing a fuse-clip.

As shown in FIG. 8, the conductor link 605 can include a first ledge 840 and a second ledge 845. The first ledge 840 may be configured to contact a surface of the transformer termination 615. The second ledge 845 may be configured to contact a surface of grounding tab 610. As illustrated in FIG. 8, the first ledge 840 and the second ledge 845 can each include a slot or region of empty space 850 and 853, respectively, configured to receive a fastening element to secure the first ledge 840 and the second ledge 845 to the transformer termination 615 and the grounding tab 610, respectively.

The conductor link 605 can include an insulation layer 855. The insulation layer 855 can completely or partially surround one or more sections 820, 825, and 830 of the conductor link 605. The insulation layer 855 can be a non-conductive material such as a plastic or rubber material.

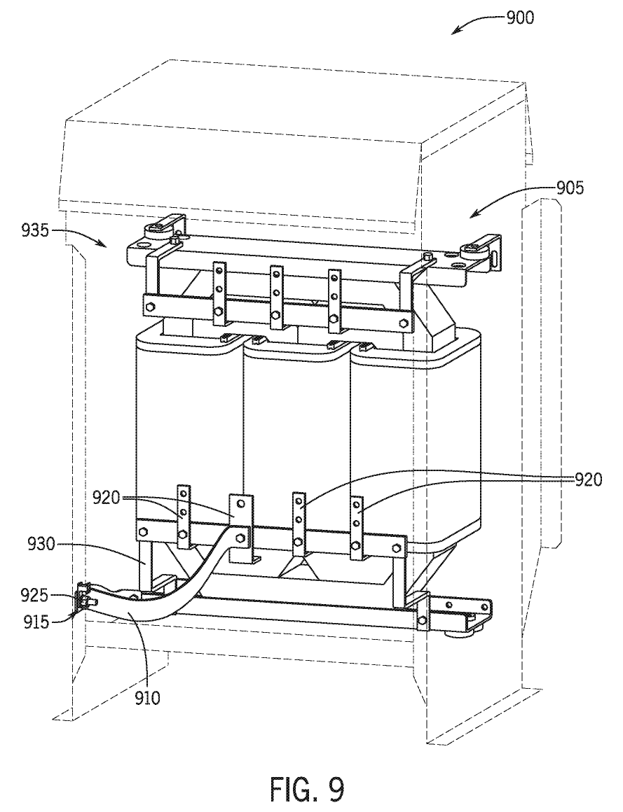

FIG. 9 illustrates a third example of a grounding and bonding provision system 900. For example, the system 900 may also provide a pre-engineered method for grounding and bonding secondary windings (or taps connected thereto) and non-current carrying metal parts 930 of a dry-type transformer 905. As illustrated in FIG. 9, the dry-type transformer 905 may be a distribution transformer. Moreover, the grounding and bonding provision system 900 can include a conductor link 910, a common grounding point 915, a transformer termination 920, and one or more electrical lug connectors 925. In some examples, the common grounding point 915 can be located inside an enclosure 935 of the dry-type transformer 905.

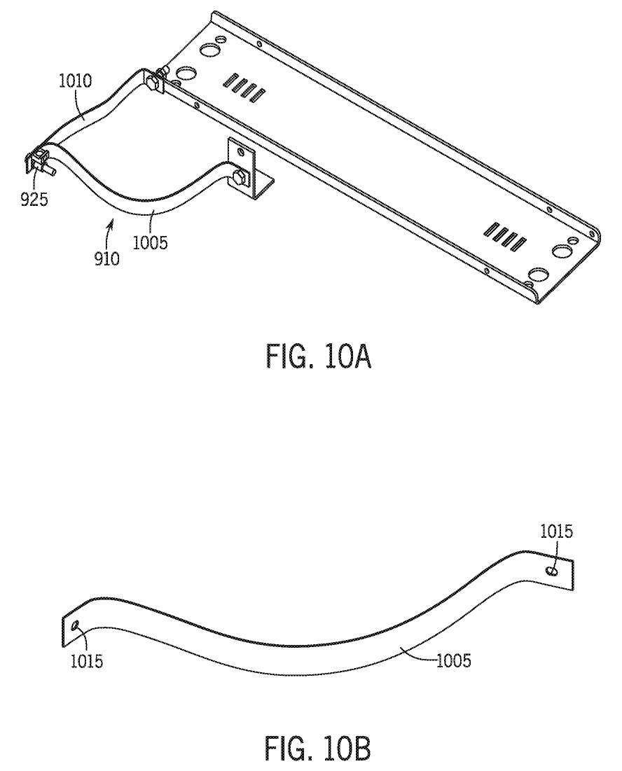

FIGS. 10A and 10B show an example of the conductor link 910. In some examples, the grounding point 915 may include a system bonding jumper 1005 and a main bonding jumper 1010. Moreover, in some examples, the system bonding jumper 1005 may connect a transformer termination 920, such as a system neutral, to the common grounding point 915 (see FIG. 9). The main bonding jumper 1010 may connect the non-current carrying metal parts 930 to the common grounding point 915. The conductor link 910 may include one or more holes 1015 that allow the electrical lug connectors 925 to be inserted and secure both the system bonding jumper 1005 and the main bonding jumper 1010 to their respective connection points.

The conductor link 910 may be constructed using one or more pieces of conductive material, such as copper. In some examples, the conductive material may be flexible, allowing the shape of the conductor link 910 to be adjusted depending on connection requirements for a given transformer. For example, the conductor link 910 may include foil strips, braided materials, simple wires, or the like.

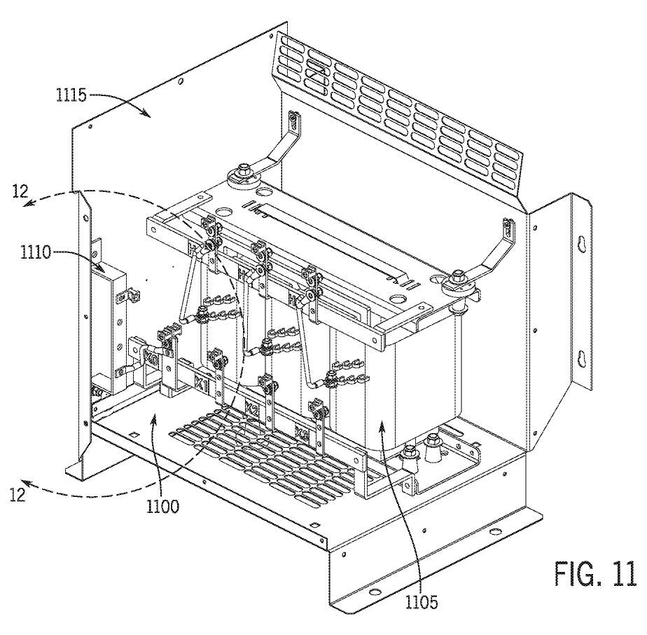

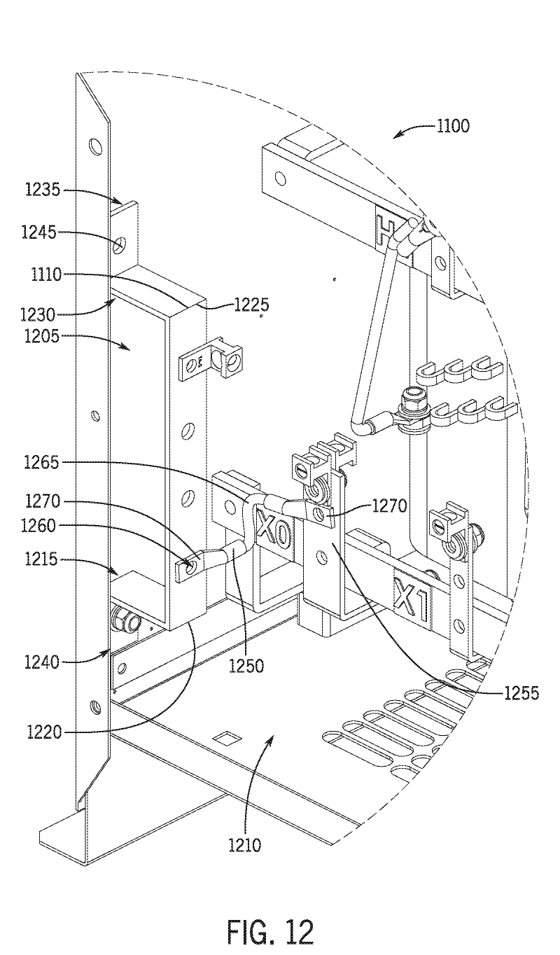

FIGS. 11 and 12 illustrate a fourth example of a grounding and bonding provision system 1100. The grounding and bonding provision system 1100 may be used with a distribution-type, dry-type transformer 1105. In some examples, grounding and bonding provision system 1100 can include a common grounding and bonding bus bar 1110 positioned inside an enclosure 1115 of the dry-type transformer 1105.

As illustrated in FIG. 12, the common grounding and bonding bus bar 1110 may be mounted on a side surface 1205 of the enclosure 1115 of the dry-type transformer 1105. In some examples, the grounding and bonding bus bar 1110 may be mounted to a bottom surface 1210 of the enclosure 1115 of the dry-type transformer 1105. The common grounding and bonding bus bar 1110 can include four bends 1215, 1220, 1225, and 1230 arranged to form a “top-hat” profile. In some examples, each of the four bends 1215, 1220, 1225, and 1230 may form a 90 degree bend. Moreover, the common grounding and bonding bus bar 1110 may include a first end 1235 and a second end 1240. The first end 1235 and the second end 1240 may each include a hole 1245 configured to receive a fastening element to secure the common grounding and bonding bus bar 1110 to the enclosure 1115 and/or the dry-type transformer 1105.

In some examples, the grounding and bonding provision system 1100 can include a grounding conductor 1250 connecting a neutral termination 1255 to a common grounding point 1260 on the common grounding and bonding bus bar 1110. In some examples, the common grounding point 1260 may be a hole or slot, wherein the grounding conductor 1250 is secured to the grounding point 1260 using a screw. Moreover, the common grounding and bonding bus bar 1110 may include more than one common grounding points 1260. As illustrated in FIG. 12, the neutral termination 1255 may be labeled “X0” in accordance with transformer terminal designations. The grounding conductor 1250 may be factory-installed during manufacturing of the dry-type transformer 1105, thereby reducing installation steps required by an installer.

Bonding of the grounding and bonding provision system 1100 may be provided by mounting the common grounding and bonding bus bar 1110 in direct electrical contact the enclosure 1115 of the dry-type transformer 1105. In some examples, a metal-to-metal contact area (not pictured) may be provided, wherein paint or other coatings are removed beneath the common and grounding bus bar 1110 to ensure proper electrical bonding between the common grounding and bonding bus bar 1110 and the enclosure 1115.

In some examples, the grounding conductor 1250 may include conductor insulation 1265. The conductor insulation 1265 may be any color (e.g., green), to indicate a grounding conductor in accordance with common industry conventions. The conductor insulation 1265 can be a non-conductive material such as a plastic or rubber material. In some examples, one or more connector ends 1270 of the grounding conductor 1250 may also be any color (e.g., green) to provide visual identification of grounding connections within the dry-type transformer 1105.

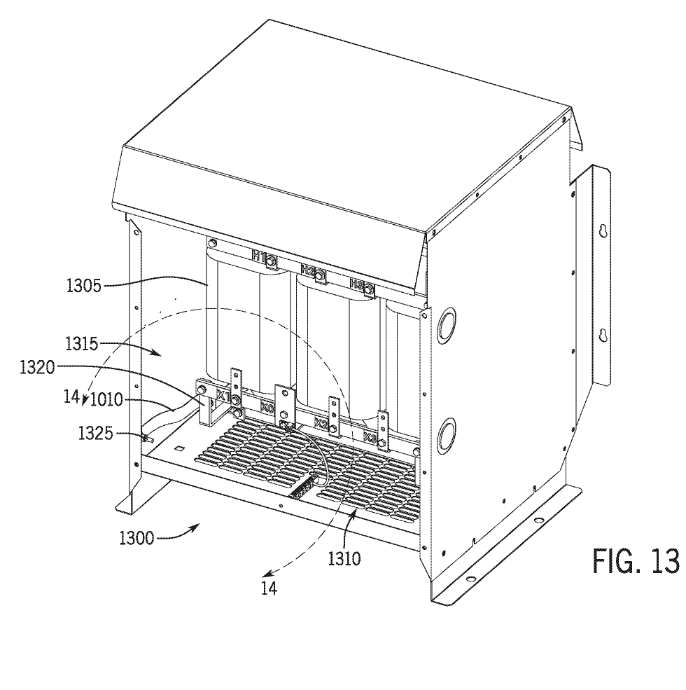

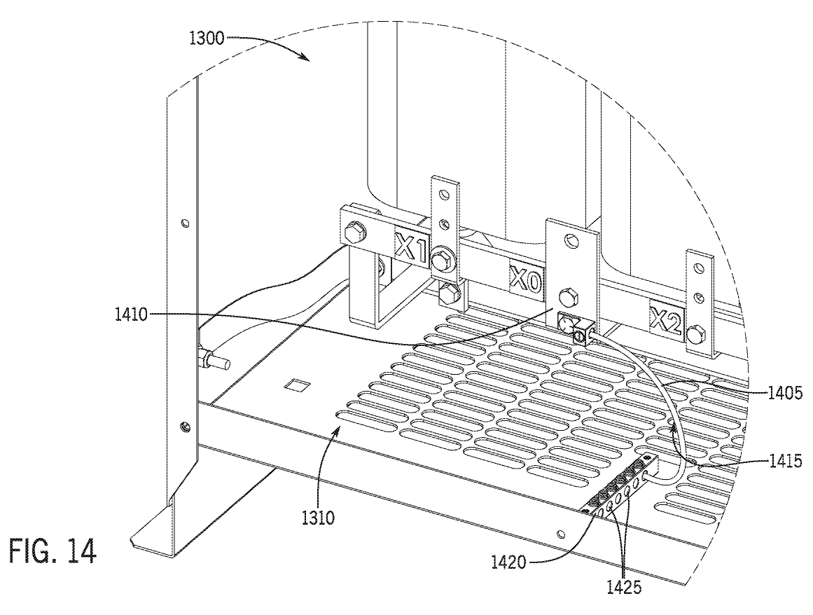

FIGS. 13 and 14 illustrate a fifth example of a grounding and bonding provision system 1300. The grounding and bonding provision system 1300 may be used with a dry-type transformer 1305. As illustrated in FIG. 14, the grounding and bonding provision system 1300 can include a grounding conductor 1405. In some examples, the grounding conductor 1405 may include conductor insulation 1415. The conductor insulation 1415 may be any color (e.g., green), to identify the grounding conductor 1405 in accordance with common industry conventions. The conductor insulation 1415 can be a non-conductive material such as a plastic or rubber material.

The grounding and bonding provision system 1300 can include a mechanical lug 1420 configured to secure the grounding conductor 1405 to the transformer termination 1410. In some examples, the mechanical lug 1420 may be a compression lug, a crimp lug, a set-screw lug, or the like. The mechanical lug 1420 may provide a secure electrical connection between the grounding conductor 1405 and the transformer termination 1410. Moreover, the mechanical lug 1420 may be secured to a bottom surface 1310 of an enclosure 1315 of the dry-type transformer 1305. As illustrated in FIG. 14, the mechanical lug 1420 may include one or more holes or openings 1425 configured to receive the grounding conductor 1405. Moreover, the grounding conductor 1405 may be secured in the hole or opening 1425 using a screw.

The grounding and bonding provision system 1300 can further include the main bonding jumper 1010, described above with respect to FIGS. 10A and 10B. The system bonding jumper 1005 may connect another transformer termination 1320 to the common grounding point 1325 located on the enclosure 1315 of the dry-type transformer 1305.

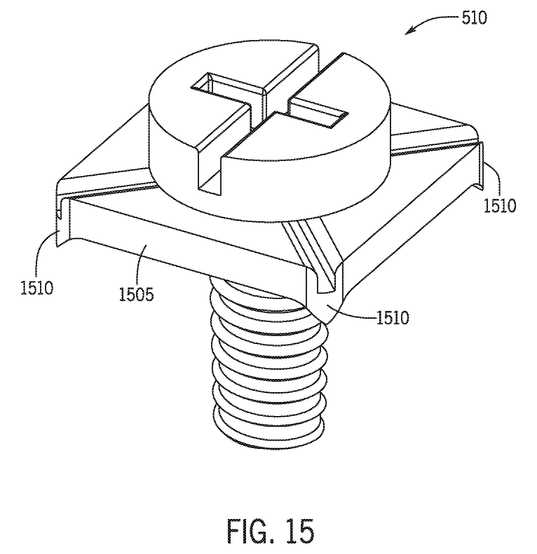

FIG. 15 shows an example of the captive washer ground screw 510, which may be used to secure the first and second ends 725, 730 to the grounding tab 610 and the transformer termination 615. In other examples, the first end 725 and/or the second end 730 may include a void, a hole, a crevasse, etc. to receive a fastening element. The captive washer ground screw 510 can include a washer plate 1505. In some examples, the capacitive washer screw 510 and the washer plate 1505 may be made from any suitable ferrous or non-ferrous material, such as plate carbon steel, stainless steel, brass, copper alloy, or the like. In some examples, the washer plate 1505 may be a spring-style that provides elastic compliance such that, when tightened to a rated torque in a terminal block, the washer plate 1505 elastically deforms and provides spring-back to maintain compressive contact force. The washer plate 1505 can be square, rectangular, round, ovular, or bellville-style and can have folded corners 1510 that can provide spring loaded clamping force. In some examples, the folded corners 1510 can each form a point. The spring loaded clamping force can secure the captive washer ground screw 510 to the grounding tab 610, along with any other termination connections, such as spade connectors, ring connectors, stranded conductors, etc.

While various spatial and directional terms, such as top, bottom, lower, mid, lateral, horizontal, vertical, front, and the like may be used to describe examples of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

It is expressly contemplated that any of the processes or steps described herein may be combined, eliminated, or reordered. In other embodiments, instructions may reside in computer readable medium wherein those instructions are executed by a processor to perform one or more of processes or steps described herein. As such, it is expressly contemplated that any of the processes or steps described herein can be implemented as hardware, firmware, software, including program instructions executing on a computer, or any combination of thereof. Accordingly, this description is meant to be taken only by way of example, and not to otherwise limit the scope of this invention.

We claim:

1. A grounding and bonding provision system, the grounding and bonding provision system comprising:
a dry-type transformer comprising a transformer termination;
a grounding tab, the grounding tab extruding from one or more non-current carrying and conductive parts of the dry-type transformer;
a conductor link, the conductor link comprising a plurality of bends arranged to position the conductor link between the grounding tab and the transformer termination; and
one or more screws removably securing the conductor link to the grounding tab and the transformer termination.

2. The grounding and bonding provision system of claim 1, wherein the plurality of bends comprises a first set of bends and a second set of bends, the first set of bends forming a U-shape, and the second set of bends forming two L-shaped portions.

3. The grounding and bonding provision system of claim 2, wherein the U-shape is configured to fit over a terminal wall of the dry-type transformer.

4. The grounding and bonding provision system of claim 1, wherein the conductor link further comprises a first end and a second end, the first end and the second end each having a region of empty space configured to receive the one or more screws.

5. The grounding and bonding provision system of claim 4, wherein the first end is secured to the transformer termination and the second end is secured to the grounding tab via the one or more screws.

6. The grounding and bonding provision system of claim 1, wherein the conductor link comprises two bends forming a first section, a second section, and a third section, the second section extending over one or more phase terminals of the dry-type transformer, and
wherein the conductor link further comprises an insulation layer surrounding at least a portion of the conductor link.

7. The grounding and bonding provision system of claim 1, wherein the one or more screws comprises at least one captive washer ground screw.

8. The grounding and bonding provision system of claim 1, further comprising:
a bus bar positioned inside an enclosure of the dry-type transformer,
wherein the conductor link comprises a grounding conductor connecting a neutral termination to the bus bar.

9. The grounding and bonding provision system of claim 1, wherein the grounding tab extends from a top surface of the dry-type transformer towards a plane defined by one or more phase terminals.

10. The grounding and bonding provision system of claim 7, wherein the at least one captive washer ground screw comprises a washer plate with folded corners.

11. A grounding and bonding provision system, the grounding and bonding provision system comprising:
a conductor link, the conductor link comprising a plurality of bends arranged to position the conductor link between a grounding tab and a transformer termination of a dry-type transformer, wherein the plurality of bends comprises:
a first 90 degree bend between a first section and a second section, the first section including a first end of the conductor link;
a second 90 degree bend between the second section and a third section, the second 90 degree bend in an opposite direction of the first 90 degree bend;
a third 90 degree bend between the third section and a fourth section, the third 90 degree bend forming a U-shape with the second 90 degree bend; and
a fourth 90 degree bend between the fourth section and a fifth section, the fifth section including a second end of the conductor link; and
one or more screws securing the conductor link to the grounding tab and the transformer termination via a first slot on the first section and/or a second slot on the fifth section.

12. The grounding and bonding provision system of claim 11, wherein the U-shape formed by the second 90 degree bend and the third 90 degree bend is configured to rest on a ledge or lip of a terminal wall of the dry-type transformer.

13. The grounding and bonding provision system of claim 11, wherein the first 90 degree bend forms a first L-shaped portion between the U-shape and the first end of the conductor link and wherein the fourth 90 degree bend forms a second L-shaped portion between the U-shape and the second end of the conductor link.

14. The grounding and bonding provision system of claim 11, wherein the first end is configured to contact a surface of the grounding tab, and the second end is configured to contact a surface of the transformer termination.

15. The grounding and bonding provision system of claim 11, wherein the conductor link comprises a conductive metal selected from one or more of: steel alloy, brass, copper, aluminum, or stainless steel.

16. An electrical control panel comprising:
a dry-type transformer comprising a transformer termination;
a grounding tab, the grounding tab coupled to one or more non-current carrying and conductive parts of the electrical control panel;
a conductor link, the conductor link comprising a plurality of bends arranged to position the conductor link between the grounding tab and the transformer termination; and
one or more screws removably securing the conductor link to the grounding tab and the transformer termination.

17. The electrical control panel of claim 16, wherein the plurality of bends comprises four bends including:
a first bend forming a 90 degree angle between a first section and a second section,
a second bend forming a 90 degree angle between the second section and a third section,
a third bend forming a 90 degree angle between the third section and a fourth section, and
a fourth bend forming a 90 degree angle between the fourth section and a fifth section.

18. The electrical control panel of claim 17, wherein the second bend and the third bend form a U-shaped portion configured to rest on a ledge or lip of a terminal wall of the dry-type transformer.

19. The electrical control panel of claim 18, wherein the first bend forms a first L-shaped portion between the U-shaped portion and a first end of the conductor link and wherein the fourth bend forms a second L-shaped portion between the U-shaped portion and a second end of the conductor link.

20. The electrical control panel of claim 16, wherein the conductor link comprises a first end configured to contact a surface of the grounding tab, and a second end configured to contact a surface of the transformer termination.
